(19) United States
(12) Patent Application Publication
(10) Pub. No.: US 2025/0348928 A1
(43) Pub. Date: Nov. 13, 2025

(54) USER INTERFACE TO AUGMENT AN IMAGE USING GEOLOCATION

(71) Applicant: Snap Inc., Santa Monica, CA (US)

(72) Inventors: Nicholas Richard Allen, Venice, CA (US); Sheldon Chang, Venice, CA (US); Timothy Michael Sehn, Marina Del Rey, CA (US); William Wu, Los Angeles, CA (US)

(21) Appl. No.: 19/274,202

(22) Filed: Jul. 18, 2025

Related U.S. Application Data
(63) Continuation of application No. 17/567,624, filed on Jan. 3, 2022, now Pat. No. 12,393,977.
Application No. 17/567,624 is a continuation of application No. 14/494,226, filed on Sep. 23, 2014, now Pat. No. 11,216,869.

(51) Int. Cl. G06Q 30/08

(52) U.S. Cl. CPC G06Q 30/08

(57) ABSTRACT

A system and method for a media filter publication application are described. The media filter publication application receives a content item and a selected geolocation, generates a media filter based on the content item and the selected geolocation, and supplies the media filter to a client device located at the selected geolocation.

### CROSS-REFERENCE TO RELATED APPLICATION

This application is a continuation of U.S. patent application Ser. No. 17/567,624, filed Jan. 3, 2022, which application is a continuation of U.S. patent application Ser. No. 14/494,226, filed Sep. 23, 2014, now issued as U.S. Pat. No. 11,216,869, which are incorporated by reference herein in their entireties.

### TECHNICAL FIELD

The subject matter disclosed herein generally relates to user interface technology. Specifically, the present disclosure addresses systems and methods for a platform for publishing context relevant media filters, for presentation on the user interfaces of mobile devices.

### BACKGROUND

The number of digital photographs taken with mobile wireless devices is increasingly outnumbering photographs taken with dedicated digital and film based cameras. Thus, there are growing needs to improve the experience associated with mobile wireless digital photography.

### BRIEF DESCRIPTION OF THE DRAWINGS

The present disclosure is illustrated by way of example, and not by way of limitation, in the figures of the accompanying drawings, in which:

FIG. 1 is a network diagram depicting a network system having a client-server architecture configured for exchanging data over a network, according to one embodiment.

FIG. 2 shows a block diagram illustrating one example embodiment of a messaging application.

FIG. 3 shows a block diagram illustrating one example embodiment of a media filter application.

FIG. 4A shows a block diagram illustrating one example embodiment of a user-based media filter publication module.

FIG. 4B shows an example of a graphical user interface for a user-based media filter publication module.

FIG. 4C shows an example of an operation of the graphical user interface of FIG. 4B.

FIG. 4D illustrates an example of a publication of a user-based media filter.

FIG. 5A shows a block diagram illustrating one example embodiment of a merchant-based media filter publication module.

FIG. 5B illustrates an example of a common geolocation.

FIG. 5C illustrates an example of a graphical user interface for a merchant-based media filter publication module.

FIG. 5D illustrates an example of a bid from a first merchant using the graphical user interface of FIG. 5C.

FIG. 5E illustrates an example of a bid from a second merchant using the graphical user interface of FIG. 5C.

FIG. 5F illustrates an example of an operation of a merchant-based media filter.

FIG. 6A shows a block diagram illustrating one example embodiment of a predefined media filter module.

FIG. 6B shows a diagram illustrating an example of a media filter with live data content.

FIG. 6C shows a diagram illustrating an example of a media filter with dynamic progressive use content.

FIG. 6D shows a diagram illustrating an example of a media filter with promotional content.

FIG. 6E shows a diagram illustrating an example of a media filter with viral content.

FIG. 7 shows an interaction diagram illustrating one example embodiment of an operation of the user-based media filter publication module.

FIG. 8 shows an interaction diagram illustrating another example embodiment of an operation of the merchant-based media filter publication module.

FIG. 9 shows a flow diagram illustrating one example embodiment of an operation of the user-based media filter publication module.

FIG. 10 shows a flow diagram illustrating one example embodiment of an operation of the merchant-based media filter publication module.

FIG. 11 shows a flow diagram illustrating one example embodiment of an operation of the live event module.

FIG. 12 shows a flow diagram illustrating one example embodiment of an operation of the social network module.

FIG. 13 shows a flow diagram illustrating one example embodiment of an operation of the promotion module.

FIG. 14 shows a flow diagram illustrating one example embodiment of an operation of the collection module.

FIG. 15 shows a flow diagram illustrating one example embodiment of an operation of the progressive use module.

FIG. 16 shows a flow diagram illustrating one example embodiment of an operation of the viral use module.

FIG. 17 shows a flow diagram illustrating one example embodiment of an operation of the actionable module.

FIG. 18 shows a diagrammatic representation of machine, in the example form of a computer system, within which a set of instructions may be executed to cause the machine to perform any one or more of the methodologies discussed herein.

FIG. 19 is a block diagram illustrating a mobile device, according to an example embodiment.

### DETAILED DESCRIPTION

Although the present disclosure is described with reference to specific example embodiments, it will be evident that various modifications and changes may be made to these embodiments without departing from the broader spirit and scope of the disclosure. Accordingly, the specification and drawings are to be regarded in an illustrative rather than a restrictive sense.

The addition of labels, drawings and other artwork to images (e.g., pictures or video) provides a compelling way for users to personalize, supplement and enhance these images before storage or publication to a broader audience. An example embodiment seeks to provide users with a set of the geo-filters (e.g., enhancement and augmentations) that can be applied to an image. The set of enhancements and augmentations, in the example form of image overlays, may be determined based on a location associated with the image. The image overlays are presented to a user for selection and combining with an image based on a determined location of the image, or content of the image. For example, where a user takes a picture on a mobile device in Disneyland, an image overlay indicating the name “Disneyland”, in a particular style, is presented to the user. Further Disneyland-themed image overlays may also be presented to the user. The presentation of the image overlay may be in response to the user performing a gesture (e.g. a swipe operation) on a screen of the mobile device. The user is then able to select the image overlay and have it applied to the image, in this way to personalize and enhance the image.

Third party entities (e.g., merchants, restaurants, individuals, etc.) may, in one example embodiment, seek to have geo-filters included in the set presented for user selection at a particular geographic location. For example, a restaurant at a particular location in San Francisco may wish to have their restaurant name and logo included in a set of geo-filters presented to a user, for the purposes of augmenting a photograph taken by the user proximate to the restaurant. According to one example embodiment, such third party entities may bid (or otherwise purchase opportunities) to have a particular geo-filter included in a set presented to a user for augmentation of a particular image. Below described are various systems and methodologies that may be used to technically implement the above described image enhancement technologies and capabilities.

More specifically, various examples of a media filter publication application are described. The media filter publication application operates at a server and generates media filters that include content based on geographic locations (also referred to as geolocation). A media filter may include audio and visual content or visual effects that can be applied to augment a media item at a mobile device. The media item may be a picture or a video. The media filter publication application includes a user-based media filter publication platform and a merchant-based publication platform.

In the user-based media filter publication platform, the media filter publication application provides a Graphical User Interface (GUI) for a user to upload content and select a geolocation on a map. For example, the user may upload a logo and define boundaries on the map to identify a particular geolocation associated with the logo. Once the user submits the logo and identifies the particular geolocation, the media filter publication application generates a media filter that includes the logo associated with the particular geolocation. As such, mobile devices that are located within the particular geolocation have access to the media filter.

In the merchant-based media filter publication platform, the media filter publication application provides a GUI for merchants to upload content, select geolocations on a map, and submit bids for the corresponding geolocations. A bidding process determines the merchant with the highest bid amount. That merchant can then exclude publication of media filters from other merchants at a selected geolocation of the merchant. Therefore, the media filter of the highest bidding merchant may be the only media filter that can be accessed by mobile devices that are located at the selected geolocation.

In other examples, the media filter includes context relevant data, such as, a current temperature, an identification of a geolocation of the mobile device (e.g., Venice beach), a name of a live event associated with the geolocation of the mobile device, or a name of a business.

In one example embodiment, a media filter application at a server provides a live event media filter to a mobile device. The live event media filter includes live event data associated with a live event, such as a sporting event or an award ceremony, at a geolocation of the mobile device. For example, a user attending a football game can access a sports media filter that includes the current score of the football game. In another example, a user attending the Oscars award ceremony can access an entertainment media filter that includes a name of an Oscar winner.

In one example embodiment, the media filter application at the server provides a social network media filter to the mobile device. The social network media filter may be based on social network activities of the user of the mobile device. For example, if the user follows a brand such as McDonald's on a social network service, and the mobile device of the user is located at a McDonald's restaurant, the mobile device of the user can access a McDonald's media filter. Other users located at the same restaurant would not have access to the McDonald's media filter unless they also follow McDonald's on the social network service. In another example, the order in which the media filters are presented to users located at a McDonald's restaurant may be modified so that the McDonald's media filter is served higher for users following McDonald's on the social network service.

In one example embodiment, the media filter application at the server provides a promotion media filter to a mobile device. The promotion media filter may be based on promotions from a merchant. For example, the media filter may be used to implement a Monopoly™ game at McDonald's by randomly selecting a media filter every time the user of the mobile device walks into a McDonald's restaurant and purchases an item. The media filter can be used to obtain Monopoly puzzle pieces that can be redeemed towards prizes.

In one example embodiment, the media filter application at the server enables the mobile device to collect media filters. For example, the mobile filter application provides the mobile device with permanent access to collected media filters. The collected media filters may be stored in a collection portfolio for the mobile device. The mobile device may access any of the media filters in the collection portfolio at any time.

In one example embodiment, the media filter application at the server provides a history media filter to the mobile device. The history media filter may be based on geographic locations of historical sites visited by the user of the mobile device. For example, the mobile device is awarded with a unique media filter associated with one of the Seven Wonders of the World when the mobile device is located at one of the corresponding Seven Wonders geographic locations.

In one example embodiment, the media filter application at the server provides a progressive use media filter to the mobile device. The content in the progressive use media filter changes depending on the number of people that have previously used the progressive use media filter.

In one example embodiment, users can “purchase” a geolocation for a predetermined amount of time and select a media filter associated with the geolocation. For example, a college can purchase and select a particular media filter associated with the geolocation of its campus.

In one example embodiment, the media filter application provides a viral media filter to the mobile device. For example, when the user of the mobile device obtains the viral media filter at a geolocation, that user can send the viral media filter to mobile devices located outside the geolocation of the original user. Users of the mobile devices located outside the geolocation of the original user can make use of the viral media filter for the next hour. Those users can also forward the viral media filter to other users.

In one example embodiment, the media filter application 122 provides an actionable media filter to the mobile device. For example, the actionable media filter can be a link to open a browser page in the mobile device to obtain a coupon. The actionable media filter can trigger other functions of the mobile device.

### System Architecture

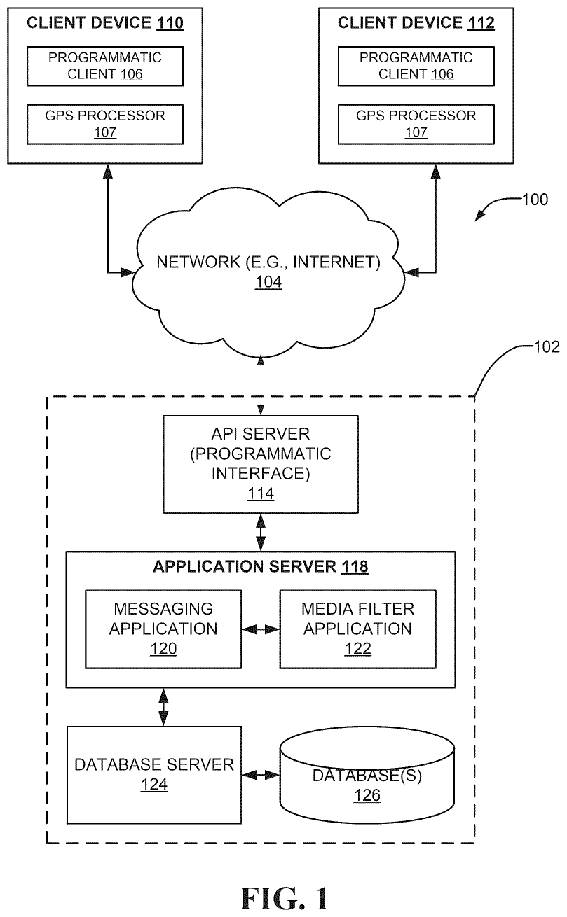

FIG. 1 is a network diagram depicting a network system 100 having a client-server architecture configured for exchanging data over a network, according to one embodiment. For example, the network system 100 may be a messaging system where clients may communicate and exchange data within the network system 100. The data may pertain to various functions (e.g., sending and receiving text and media communication, determining geolocation) and aspects (e.g., publication of media filters, management of media filters) associated with the network system 100 and its users. Although illustrated herein as client-server architecture, other embodiments may include other network architectures, such as peer-to-peer or distributed network environments.

A data exchange platform, in an example, includes a messaging application 120 and a media filter application 122, and may provide server-side functionality via a network 104 (e.g., the Internet) to one or more clients. The one or more clients may include users that utilize the network system 100 and, more specifically, the messaging application 120 and the media filter application 122, to exchange data over the network 104. These operations may include transmitting, receiving (communicating), and processing data to, from, and regarding content and users of the network system 100. The data may include, but is not limited to, content and user data such as user profiles, messaging content, messaging attributes, media attributes, client device information, geolocation information, photo filters content, messaging content persistence conditions, social network information, and live event data information, among others.

In various embodiments, the data exchanges within the network system 100 may be dependent upon user-selected functions available through one or more client or user interfaces (UIs). The UIs may be associated with a client machine, such as client devices 110, 112 using a programmatic client 106, such as a client application. The programmatic client 106 may be in communication with the messaging application 120 and media filter application 122 via an application server 118. The client devices 110, 112 include mobile devices with wireless communication components, and audio and optical components for capturing various forms of media including photos and videos.

Turning specifically to the messaging application 120 and the media filter application 122, an application program interface (API) server 114 is coupled to, and provides programmatic interface to one or more application server(s) 118. The application server 118 hosts the messaging application 120 and the media filter application 122. The application server 118 is, in turn, shown to be coupled to one or more database servers 124 that facilitate access to one or more databases 126.

The API server 114 communicates and receives data pertaining to messages and media filters, among other things, via various user input tools. For example, the API server 114 may send and receive data to and from an application (e.g., the programmatic client 106) running on another client machine (e.g., client devices 110, 112 or a third party server).

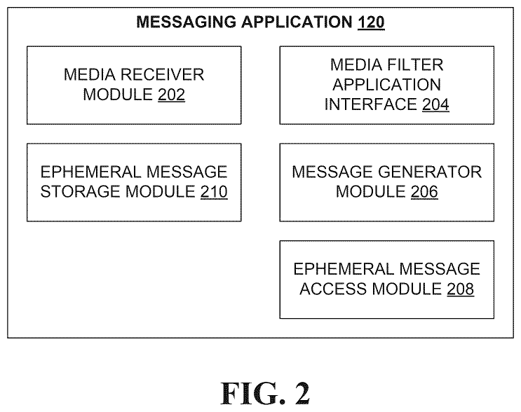

In one example embodiment, the messaging application 120 provides messaging mechanisms for users of the client devices 110, 112 to send messages that include text and media content such as pictures and video. The client devices 110, 112 can access and view the messages from the messaging application 120 for a limited period of time. For example, the client device 110 can send a message to the client device 112 via the message application 120. Once the client device 112 accesses the message from the message application 120, the message is deleted after a predefined duration has elapsed from the time the client device 112 started viewing the message. Components of the messaging application 120 are described in more detail below with respect to FIG. 2.

In one example embodiment, the media filter application 122 provides a system and a method for operating and publishing media filters for messages processed by the messaging application 120. The media filter application 122 supplies a media filter to the client device 110 based on a geolocation of the client device 110. In another example, the media filter application 122 supplies a media filter to the client device 110 based on other information, such as, social network information of the user of the client device 110.

The media filter may include audio and visual content and visual effects. Examples of audio and visual content include pictures, texts, logos, animations, and sound effects. An example of a visual effect includes color filtering. The audio and visual content or the visual effects can be applied to a media content item (e.g., a photo) at the client device 110. For example, the media filter includes text that can be overlaid on top of a photo generated at the client device 110. In another example, the media filter includes an identification of a location overlay (e.g., Venice beach), a name of a live event, or a name of a merchant overlay (e.g., Beach Coffee House). In another example, the media filter application 122 uses the geolocation of the client device 110 to identify a media filter that includes the name of a merchant at the geolocation of the client device 110. The media filter may include other indicia associated with the merchant. Examples of indicia include logos and other pictures related to the merchant. The media filters may be stored in the database(s) 126 and accessed through the database server 124.

In one example embodiment, the media filter application 122 includes a user-based publication platform that enables users to select a geolocation on a map, and upload content associated with the selected geolocation. The user may also indicate other circumstances under which a particular media filter should be provided. The media filter application 122 generates a media filter that includes the uploaded content and associates the uploaded content with the selected geolocation.

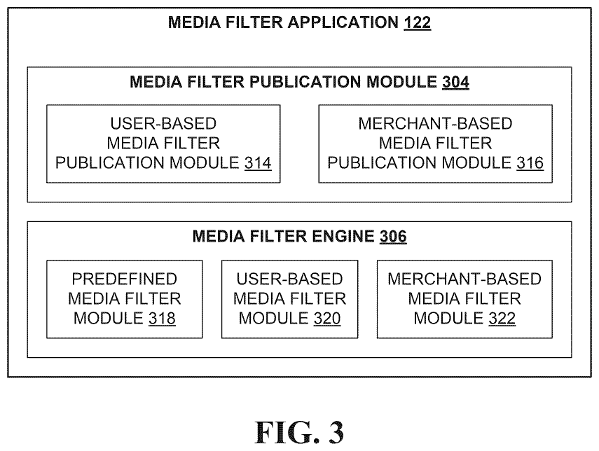

In another example embodiment, the media filter application 122 includes a merchant-based publication platform that enables merchants to select a particular media filter associated with a geolocation via a bidding process. For example, the media filter application 122 associates the media filter of a highest bidding merchant with a corresponding geolocation for a predefined amount of time. Components of the media filter application 122 are described in more detail below with respect to FIG. 3.

### Messaging Application

FIG. 2 shows a block diagram illustrating one example embodiment of the messaging application 120. The messaging application 120 may be hosted on dedicated or shared server machines (not shown) that are communicatively coupled to enable communications between server machines. The messaging application 120 and the media filter application 122 themselves are communicatively coupled (e.g., via appropriate interfaces) to each other and to various data sources, so as to allow information to be passed between the messaging application 120 and the media filter application 122, or so as to allow the messaging application 120 and the media filter application 122 to share and access common data. The messaging application 120 and the media filter application 122 may, furthermore, access the one or more databases 126 via the database server(s) 124.

The messaging application 120 is responsible for the generation and delivery of messages between users of the programmatic client 106. The messaging application 120 may utilize any one of a number of message delivery networks and platforms to deliver messages to users. For example, the messaging application 120 may deliver messages using electronic mail (e-mail), instant message (IM), Short Message Service (SMS), text, facsimile, or voice (e.g., Voice over IP (VOIP)) messages via wired (e.g., the Internet), plain old telephone service (POTS), or wireless networks (e.g., mobile, cellular, WiFi, Long Term Evolution (LTE), Bluetooth).

In one example embodiment, the messaging application 120 includes a media receiver module 202, a media filter application interface 204, a message generator module 206, an ephemeral message access module 208, and an ephemeral message storage module 210. The media receiver module 202 receives a message from the programmatic client 106 of the client device 110. The message may include a combination of text, photo, or video. The media receiver module 202 also receives persistence metadata associated with the message. The persistence metadata defines how long a message can be viewed. For example, the user of client device 110 may specify that the message be persistent or can only be viewed or accessed for a user-determined amount of time (e.g., ten seconds). The media filter application interface 204 communicates with the media filter application 122 to access and retrieve a media filter associated with the metadata in the message. The message generator module 206 applies the media filter to the message from the programmatic client 106 to create an ephemeral message and temporarily store the ephemeral message with the ephemeral message storage module 210.

The ephemeral message access module 208 notifies a recipient of the message of the availability of the ephemeral message. The ephemeral message access module 208 receives a request to access the ephemeral message from the recipient and causes the ephemeral message to be displayed on a client device of the recipient for the maximum duration specified in the persistence metadata. Once the recipient views the message for the maximum duration, the ephemeral message access module 208 causes the client device of the recipient to stop displaying the ephemeral message, and deletes the ephemeral message from the ephemeral message storage module 210.

### Media Filter Application

FIG. 3 shows a block diagram illustrating one example embodiment of the media filter application 122. The media filter application 122 includes a media filter publication module 304 and a media filter engine 306.

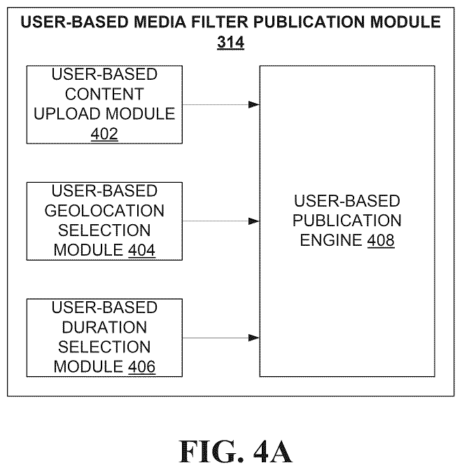

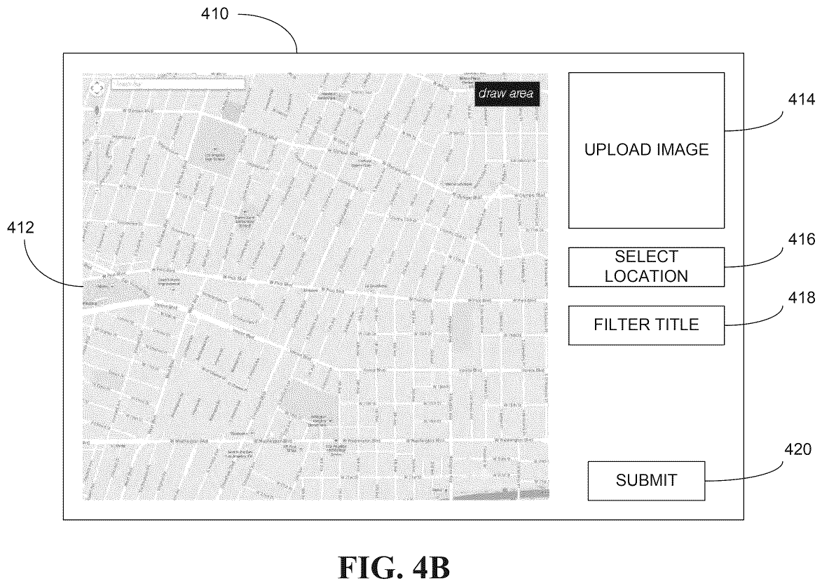

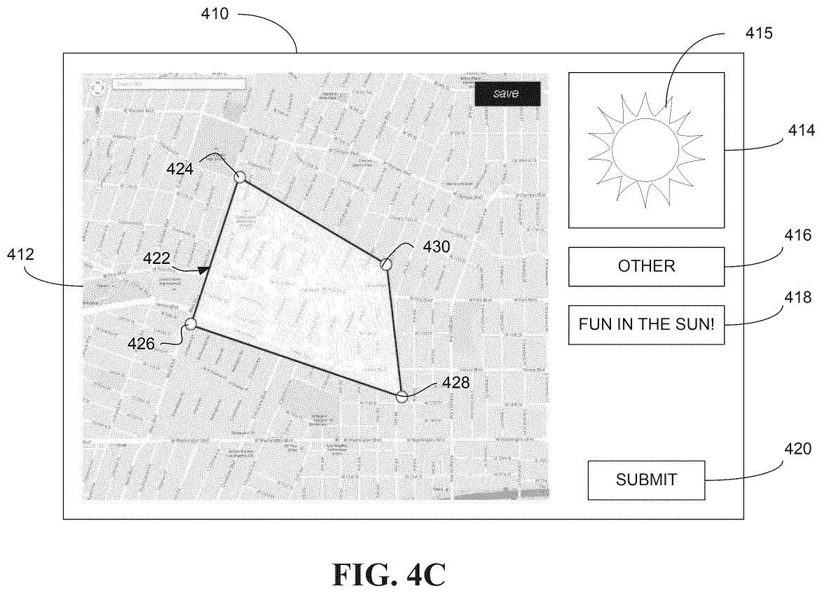

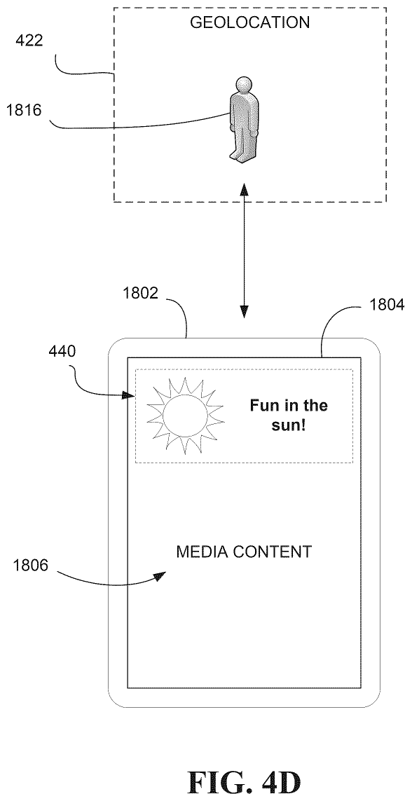

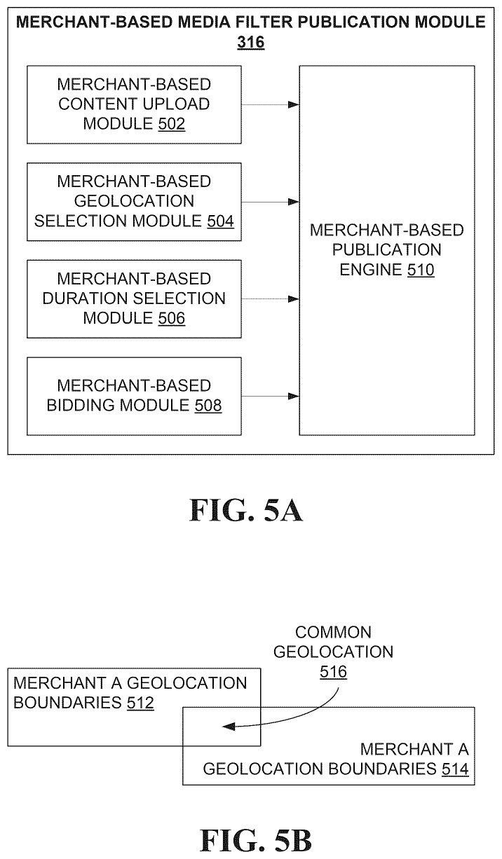

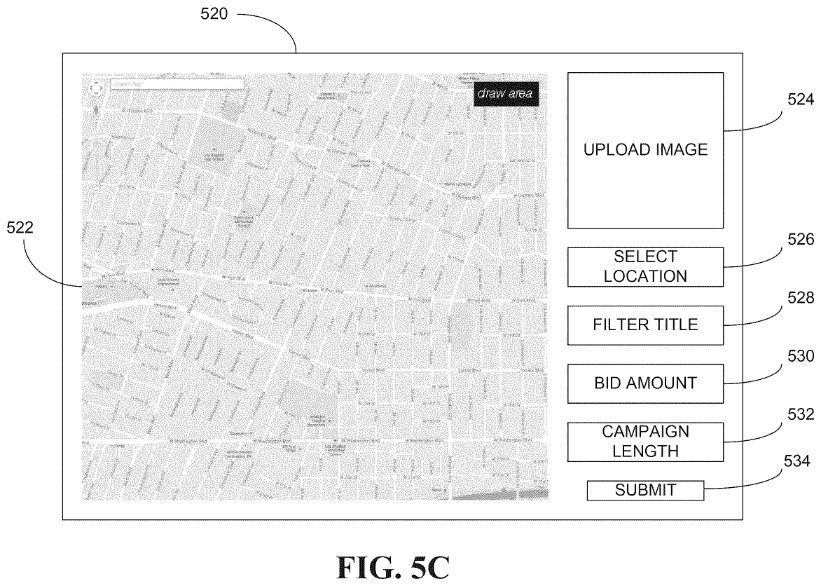

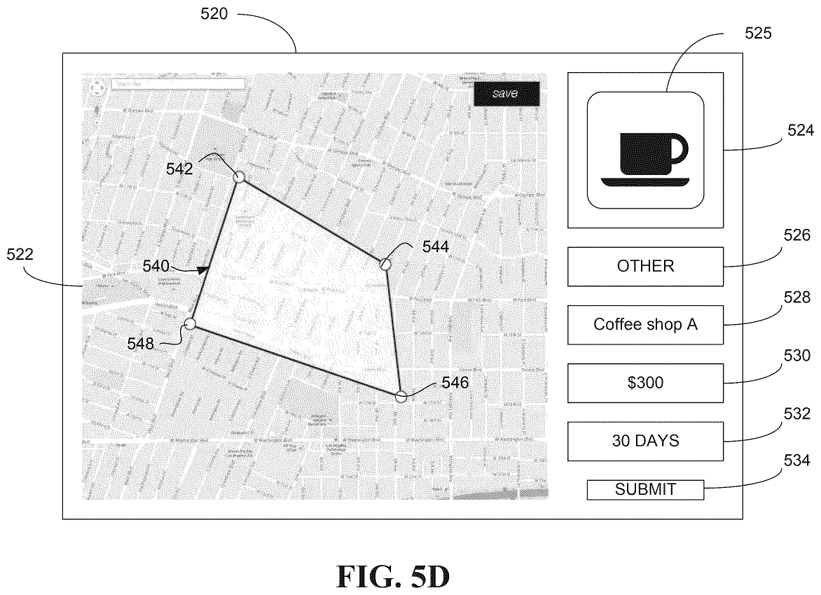

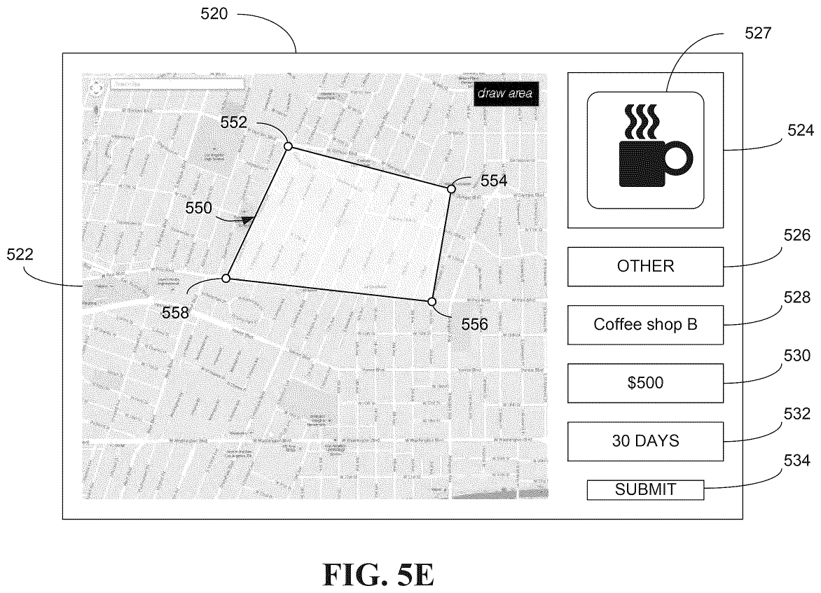

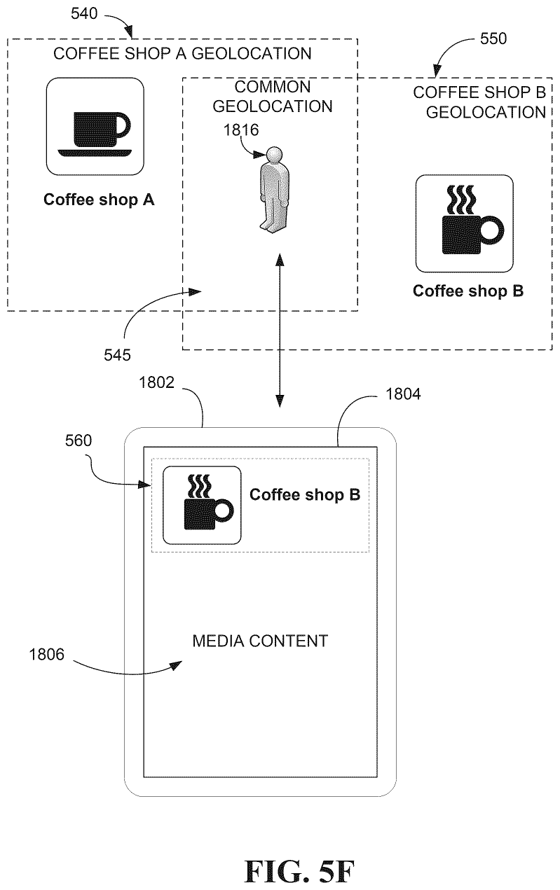

The media filter publication module 304 provides a platform for publication of media filters. In an example embodiment, the media filter publication module 304 includes a user-based media filter publication module 314 and a merchant-based media filter publication module 316. The user-based media filter publication module 314 enables users of client devices (either mobile or web clients) to upload content and select a geolocation for a user-based media filter. The merchant-based media filter publication module 316 enables merchants to upload content, select a geolocation, and submit a bid amount for a merchant-based media filter. The user-based media filter publication module 314 is described in more detail below with respect to FIG. 4A. The merchant-based media filter publication module 316 is described in more detail below with respect to FIG. 5A.

The media filter engine 306 generates and supplies a media filter based on the geolocation of a client device. In one example embodiment, the media filter engine 306 includes a predefined media filter module 318, a user-based media filter module 320, and a merchant-based media filter module 322. The media filter may be based on predefined media filters from the predefined media filter module 318, user-based media filters from the user-based media filter module 320, and merchant-based media filters from the merchant-based media filter module 322.

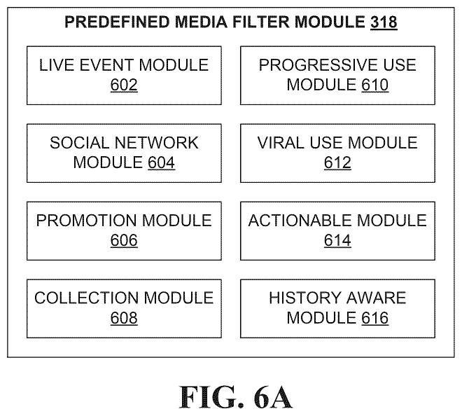

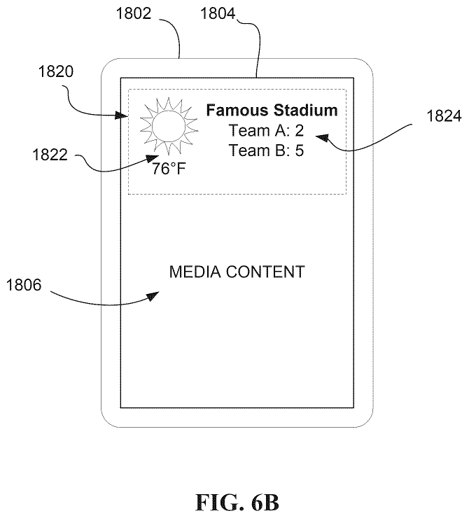

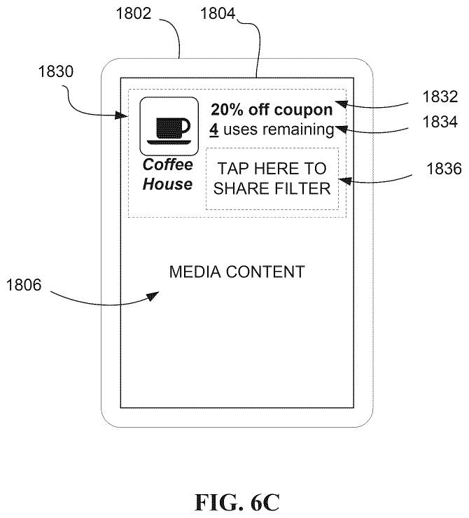

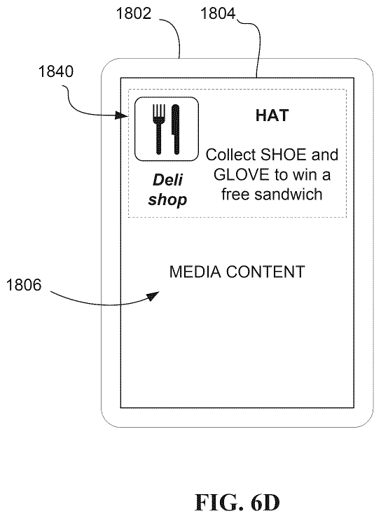

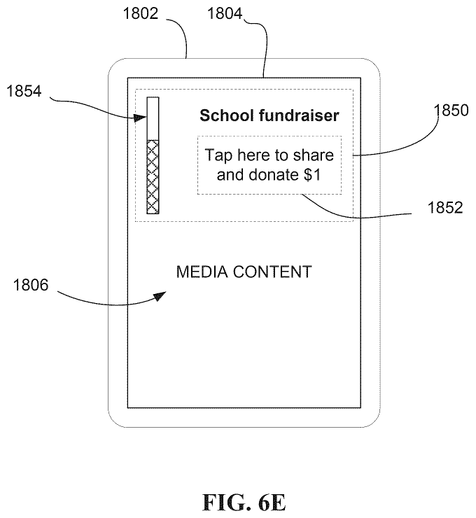

The predefined media filter module 318 supplies the client device with one of predefined media filters. Examples of predefined media filters are described in more detail below with respect to FIG. 6.

The user-based media filter module 320 supplies the client device with a user-based media filter generated by the user-based media filter publication module 314. The merchant-based media filter module 322 supplies the client device with a merchant-based media filter generated by the merchant-based media filter publication module 316.

FIG. 4A shows a block diagram illustrating one example embodiment of the user-based media filter publication module 314. The user-based media filter publication module 314 includes a user-based content upload module 402, a user-based geolocation selection module 404, a user-based duration selection module 406, and a user-based publication engine 408.

The user-based content upload module 402 receives uploaded content from a user. The content may include a media item such as a photo or a video. The user-based content upload module 402 may be implemented on a web server to allow a user to upload the content using a GUI as illustrated in FIG. 4B.

The user-based geolocation selection module 404 receives geolocation identification information from the user to identify a selected geolocation. The geolocation identification information may include an address, an identification of an establishment already associated with the address, Global Positioning System (GPS) coordinates, or a geographic boundary. For example, the address may include a street number, street address, city, state, and country. The user may also identify a location based on an existing establishment. For example, the geolocation information may include “restaurant x” in Venice Beach. The geographic boundary identifies a region or a zone. For example, the geographic boundary may define a region located within a predetermined radius of an address, a point of interest, or a name of an existing establishment.

In one example embodiment, the geolocation identification information may be embedded in a message or communication from a client device to the user-based geolocation selection module 404. For example, the user of the client device may take a picture of a sunset at Venice Beach and send the picture to the user-based geolocation selection module 404 that may then extract the geolocation attribute from the metadata associated with the picture of the sunset. The user-based geolocation selection module 404 may be implemented on a web server to present a user with a GUI in a web page that allows the user to select the geolocation for the content as illustrated in FIG. 4C.

The user-based duration selection module 406 receives, from the user, time duration information related to the uploaded content and selected geolocation. The time duration may identify a period of time during which the uploaded content is associated with the selected geolocation. Once the period of time has elapsed, the uploaded content is no longer associated with the selected geolocation. For example, if the time duration indicates twenty four hours, the media filter engine 306 makes the user-based media filter available to client devices that are located at the selected geolocation. Once twenty four hours has elapsed, the user-based media filter is no longer accessible by the client devices at the selected geolocation.

Other embodiments include a periodic time duration information or specific time duration information. For example, for the periodic time duration information, the user-based media filter is published and made available at the selected geolocation every Sunday (e.g., a religion related media filter available on days of religious services). For the specific time duration information, the user-based media filter is published and made available at the selected geolocation around a specific holiday or date (e.g., Thanksgiving weekend, New Year's day).

The user-based publication engine 408 generates a user-based media filter that associates the uploaded content from the user-based content upload module 402 with the selected geolocation from the user-based geolocation selection module 404. The user-based publication engine 408 publishes the user-based media filter to client devices that are located within the selected geolocation for the time duration identified with the user-based duration selection module 406.

In another example embodiment, the user-based publication engine 408 determines that no other user-based media filters exist during the same period of time for the same selected geolocation. The user-based media filter publication engine 408 may publish just one user-based media filter at any time for the same selected geolocation. In another example embodiment, a limit may be placed on the number of user-based media filters available at any time for the same selected geolocation. Thus, the user-based media filter publication engine 408 may publish and make available a limited number of user-based media filters at any time for the same selected geolocation. In another example embodiment, user-based media filters may be published to only contacts or ‘friends’ of the uploading user.

FIG. 4B illustrates an example of a GUI 410 for uploading content and for selecting a geographic region on a map. The GUI 410 includes a map 412, an upload image box 414, a select location button 416, a filter title box 418, and a submit button 420. The upload image box 414 enables a user to upload content, (e.g., a picture) to the user-based content upload module 402. The select location button 416 enables the user to identify a geolocation by drawing boundaries on the map 312 or by inputting an address or a zip code. The identified geolocation is submitted to the user-based geolocation selection module 404. The filter title box 418 enables the user to submit a name for the media filter. The user may submit the content and the requested geolocation by clicking on the submit button 420. Once the content and requested geolocation are submitted, the user-based publication engine 408 generates a user-based media filter that includes the uploaded content for the identified geolocation.

FIG. 4C illustrates an example where user identified boundaries points 424, 426, 428, and 430 on the map 412 define a geolocation 422. The user has uploaded a picture of the sun 415 displayed in the upload image box 414. The user has entered the title of the content “Fun in the sun!” in the filter title box 418. The user may submit the picture of the sun 415 and the geolocation 422 by clicking on the submit button 420. Once the picture of the sun 415 and the geolocation 422 are submitted, the user-based publication engine 408 generates a user-based media filter.

FIG. 4D illustrates an example of a publication of a user-based media filter. The media filter application 122 detects that a mobile device 1802 of a user 1816 is located at the geolocation 422. The media filter application 122 retrieves the user-based media filter 440 corresponding to the geolocation 422 and publishes the user-based media filter 440 to the mobile device 1802. The user-based media filter 440 is applied to media content 1806 in a display 1804 of the mobile device 1802.

FIG. 5A shows a block diagram illustrating one example embodiment of the merchant-based media filter publication module 316. The merchant-based media filter publication module 316 includes a merchant-based content upload module 502, a merchant-based geolocation selection module 504, a merchant-based duration selection module 506, a merchant-based bidding module 508, and a merchant-based publication engine 510.

The merchant-based content upload module 502 receives content from a merchant. The content may include a media item such as a picture, a video, a graphic, or a text. The merchant-based content upload module 502 may be implemented on a web server to allow a merchant to upload the content using a webpage.

The merchant-based geolocation selection module 504 receives geolocation identification information from the merchant to identify a selected geolocation. The geolocation identification information may include an address of an establishment, an identification of an establishment already associated with the address, GPS coordinates, or a geographic boundary. For example, the address of the establishment may include a street number, street address, city, state, and country. The merchant may also identify a location based on an existing establishment. For example, the geolocation information may include “restaurant x” in Venice beach. The geographic boundary identifies a region or a zone. For example, the geographic boundary may define a region located within a predetermined radius of an address, a point of interest, or a name of an existing establishment. The merchant may further define the geographic boundary by drawing a virtual fence on a map. The merchant-based geolocation selection module 504 may be implemented on a web server to allow a merchant to draw boundaries on a map in a web page.

The merchant-based duration selection module 506 receives, from the merchant, time duration information related to the uploaded content and selected geolocation. The time duration may identify a period of time in which the uploaded content is associated with the selected geolocation. Once the period of time has elapsed, the uploaded content is no longer associated with the selected geolocation. Other embodiments include periodic time duration information or specific time duration information. For example, for the periodic time duration information, the merchant-based media filter is published or made available at the selected geolocation (e.g., corner of two identified streets) every Saturday night (e.g., a night club related media filter available every Saturday night). For the specific time duration information, the selected media filter is published or made available at the selected geolocation around a specific date (e.g., party event date).

The merchant-based bidding module 508 provides an interface to enable merchants to submit a bid amount for a common geolocation. The common geolocation may include, for example, a same street address. For example, several businesses may have the same street address but different suite numbers in a shopping center. FIG. 5B illustrates an example of a common geolocation. Merchant A geolocation boundaries 512 overlaps with merchant B geolocation boundaries 514 to define a common geolocation 516. Thus, merchants A and B may submit respective bids corresponding to the common geolocation 516. In one example embodiment, the merchant-based geolocation selection module 504 determines common geolocations from the geolocations selected by the merchants. The merchant-based bidding module 508 identifies a highest bidder for the common geolocation and awards the highest bidder with the ability to exclude other merchant-based media filters from the common geolocation 516 for a predefined amount of time.

In another example embodiment, the merchant-based bidding module 508 prorates bid amounts based on their corresponding time duration information. For example, merchant A submits a bid amount of $100 for one day for a specific geolocation. Merchant B submits a bid amount of $160 for two days for the same specific geolocation. The merchant-based bidding module 508 may prorate the bid from merchant B for one day (e.g., $80) and compare both bids for the same period of time (e.g., one day) to determine a highest bidder.

The merchant-based publication engine 510 generates a merchant-based media filter that associates the uploaded content of the highest bidder with the geolocation identified by the highest bidder. The merchant-based publication engine 510 publishes the merchant-based media filter to client devices that are located at the geolocation selected by the highest bidder for the time duration identified with the merchant-based duration selection module 506. Merchant-based media filters from other merchants in the common geolocation 516 are excluded from publication. In another embodiment, a quota may be placed on the number of merchant-based media filters available for the common geolocation 516. For example, the merchant-based publication engine 510 may publish and make available a limited number of merchant-based media filters (e.g., a maximum of two merchant-based media filters) for the common geolocation 516.

In another example embodiment, the merchant-based publication engine 510 forms a priority relationship that associates the uploaded content of the highest bidder with the geolocation selected by the highest bidder. For example, an order in which media filters are displayed at the client device 110 may be manipulated based on the results from the merchant-based bidding module 508. A media filter of a merchant with the highest bid may be prioritized and displayed first at the client device 110. Media filters from other merchants may be displayed at the client device 110 after the media filter of the highest bidder. In another example embodiment, a merchant may be able to bid on all locations at which it maintains a presence. Thus, a restaurant chain may be able to have its media filter(s) published at each of its restaurant chain locations.

FIG. 5C illustrates an example of a GUI 520 for uploading content and for selecting a geolocation on a map. The GUI 520 includes a map 522, an upload image box 524, a select location button 526, a filter title box 528, a bid amount entry box 530, a campaign length entry box 532, and a submission button 534. The upload image box 524 enables a merchant to upload content (e.g., a picture, a video, or an animation) to the merchant-based content upload module 502. The selection location button 526 enables the merchant to identify a geolocation by drawing boundaries on the map 522 or by inputting an address or a zip code. The filter title box 528 enables the merchant to submit a name for the media filter. The bid amount entry box 530 enables the merchant to enter a bid amount for the identified geolocation. The campaign length entry box 532 enables the merchant to specify a length of a campaign in which the uploaded content is associated with the identified geolocation. The merchant may submit the uploaded content and entered information by clicking on the submit button 534.

FIG. 5D illustrates an example where a merchant A has identified boundaries points 542, 544, 546, and 548 on the map 522 to define a geolocation 540. Merchant A has uploaded a picture 525 displayed in the upload image box 524. Merchant A has entered a title “Coffee shop A” in the filter title box 528, a bid amount of $300 in the bid amount entry box 530, and a campaign length of 30 days in the campaign length entry box 532. Merchant B submits the picture 525, the requested geolocation 540, and other entered information by clicking on the submit button 534. The merchant-based publication engine 510 generates a media filter for merchant A.

FIG. 5E illustrates an example where another merchant, merchant B, has identified boundaries points 552, 554, 556, and 558 on the map 522 to define a geolocation 550. Merchant B has uploaded a picture 527 displayed in the content upload box 524. Merchant B has entered a title “Coffee shop B” in the filter title box 528, a bid amount of $500 in the bid amount entry box 530, and a campaign length of 30 days in the campaign length entry box 532. Merchant B may submit the picture 527, the requested geolocation 550, bid amount, and campaign length by clicking on the submission button 534. The merchant-based publication engine 510 generates a media filter for merchant B.

FIG. 5F shows a diagram illustrating an example of a merchant-based media filter selected based on a bidding process. The geolocation 540 of merchant A and the geolocation 550 of merchant B overlap at a common geolocation 545. The user 1816 is located at the common geolocation 545 and uses his mobile device 1802 to generate the media content 1806 (e.g., user 1816 takes a picture) in the display 1804 of the mobile device 1802. The media filter of the merchant with the highest bid for the common location 545 is published to the mobile device 1802. In the present example, merchant B has outbid merchant A. As such, media filter 560 of merchant B is provided and displayed in the display 1804 on top of the media content 1806. The media filter 560 contains the uploaded content from merchant B. In addition, it should be noted that ‘merchant’ in the context of the current example embodiments may include not only entities involved in the trade or sale of merchandise but any other entity as well, including individuals, universities, non-profit organizations, student organizations, clubs, etc.

FIG. 6A shows a block diagram illustrating one example embodiment of the predefined media filter module 318. The predefined media filter module 318 includes, for example, a live event module 602, a social network module 604, a promotion module 606, a collection module 608, a progressive use module 610, a viral use module 612, an actionable module 614, and a history aware module 616.

The live event module 602 generates a media filter based on live event information. The live event information may be related to a live game score of a sporting event associated with a corresponding geolocation, or a live news event related to an entertainment or social event associated with a corresponding geolocation. For example, a user of the client device 110 attends a game at a stadium. As such, media metadata from the client device 110 may identify the location of the stadium with a date and time. The live event module 402 uses that information to search for a live event associated with the location of the stadium, date, and time. The live event module 602 retrieves a current or nearly current game score associated with the live sporting event at the stadium (via e.g., the ESPN API). The live event module 602 may also retrieve insignias or team logos associated with the live sporting event. As such, the live event module 602 generates a media filter containing the latest score based on news sources covering the live sporting event.

In another example, the user of the client device 110 attends a social event at a venue. Similarly, media metadata identifies the location of the venue with a date and time. The live event module 602 uses that information to search for a live event associated with the location of the venue, date, and time from sources such as a social network server or news media service. The live event module 602 retrieves a news feed associated with the live social event at the venue. As such, the live event module 602 generates a media filter containing information or content based on news retrieved from a news feed associated with the live social event at the venue.

The social network module 604 generates a media filter based on social network information of a user of the client device 110. The social network information may include social network data retrieved from a social network service provider. The social network data may include profile data of the user, “likes” of the user, establishments that the user follows, friends of the user, and postings of the user among others. For example, the media filter associated with a restaurant may be available to the user at the location of the restaurant if the user has identified himself as a fan of the restaurant or indicates a “like” of the restaurant with the social network service provider. In another example, the ranking or priority of displaying the media filter in the client device 110 of the user may be based on the profile of the user or the number of “check-ins” of the user at the restaurant.

In another example embodiment, the media filter may be restricted and available only to the user and the social network (e.g., friends or other users in different categories) of the user of the client device 110. As such, the user may forward the media filter to his friends.

The promotion module 606 generates media filters for a promotion (e.g., a game, contest, lottery). For example, a set of unique media filters may be generated. One media filter from the set of unique media filters may be provided to the client device 110 when the client device 110 is at a predefined location associated with the media filters. For example, the user may visit a fast food restaurant. The media metadata from the client device 110 identifies the location of the fast food restaurant. The promotion module 606 retrieves a unique media filter from the set of unique media filters and provides it to the client device 110. The promotion module 606 may remove the unique media filter from the set of unique media filters after it has been provided to the client device 110. In another embodiment, the promotion module 406 removes the unique media filter from the set of unique media filters after it has been provided to other client devices for a predefined number of times.

The media filter includes content related to a game or promotion. In another example, the media filter may include dynamic content adjusted based on the game or promotion. For example, the dynamic content may include a current number of remaining media filters of the game or promotion. The media filters from the promotion module 606 may be “collected” by the client device 110. For example, the client device 110 may store the media filter in a collection at the client device 110. A prize may be redeemed upon collection of each filter of a predefined set of media filters.

The collection module 608 generates collectible media filters. For example, the client device 110 is provided with a media filter associated with the geolocation of the client device 110. The media filter may be collected by the client device 110 and be made permanently available to the client device 110. The client device 110 may store the collected media filter in a collection folder at the client device 110.

The progressive use module 610 generates media filters with dynamic content that changes based on a number of uses of the media filters. For example, a media filter can be set to be used for a limited number of times. Every time the media filter is provided to a client device, a content of the media filter is adjusted. For example, the media filter may include a fundraising progress bar in which a level of the bar rises every time the media filter is used. The dynamic content in the media filter may include a countdown displaying the number of remaining usage of the media filter.

The viral use module 612 generates media filters that can be forwarded to other users outside a geolocation associated with the media filters. For example, the client device 110 receives a media filter based on a geolocation of the mobile device 110. The client device 110 can send the media filter to mobile device 112 that is outside the geolocation of the mobile device 110. The forwarded media filter may be available for use by the mobile device 112 for a predefined time limit (e.g., one hour). Similarly, the mobile device 112 may forward the media filter to other mobile devices outside the geolocation of the mobile device 110 for use within the predefined time limit.

The actionable module 614 generates media filters with an action associated with a content of the media filter. For example, the media filter can start a browser of the client device 110 and open a predetermined website in the browser. In another embodiment, the media filter is capable of opening other functionalities (e.g., payment application) or executing other programs at the client device 110. For example, a user can tap on the media filter to download or display a coupon associated with the media filter at the client device 110.

The history aware module 616 generates media filters based on geolocation of the mobile device 110 and historical events associated with the geolocation. For example, a media filter may include pictures of a pyramid associated with the geolocation of the mobile device 110. The media filters may be collected based on the historical events or, for example, for each of the Seven Natural Wonders of the World. For example, a media filter associated with a national park may be collected when the user visits the national park. The device can collect all media filters associated with all national parks.

FIG. 6B shows a diagram illustrating an example of a media filter 1820 with live data content. The media filter 1820 contains live data associated with a geolocation of the mobile device 1802. For example, the live data contains a live weather status 1822 and latest score update 1824 of a sporting event associated with the geolocation of the mobile device 1802. The mobile device 1802 displays the media filter 1820 on top of (i.e., as a transparent overlay) the media content 1806. In one example embodiment, the media filter 1820 may be implemented with the live event module 602 of FIG. 6A.

FIG. 6C shows a diagram illustrating an example of a media filter 1830 with promotional content. For example, the media filter 1830 includes a digital coupon 1832 that can be redeemed at a coffee shop. The media filter 1830 may include dynamic content 1834. For example, the dynamic content 1834 may include a remaining number of times the coupon can be used. Furthermore, the media filter 1830 may include an actionable area 1836 that is associated with an executable function. For example, when the user taps the actionable area 1836, the media filter 1830 is forwarded to a mobile device of a friend of the user. The mobile device 1802 displays the media filter 1830 on top of the media content 1806. In one example embodiment, the media filter 1830 may be implemented with the social network module 604, the promotion module 606, the progressive use module 610, and the actionable module 614 of FIG. 6A.

FIG. 6D shows a diagram illustrating an example of a collectible media filter 1840. The collectible media filter 1840 may be randomly supplied to the mobile device 1802 in response to detecting the mobile device 1802 at a geolocation associated with the collectible media filter 1840. The collectible media filter 1840 can be stored at the mobile device 1802. Once the mobile device 1802 detects that related collectible media filters have been stored, the mobile device 1802 may cause the related collectible media filters or a corresponding unique media filter to be displayed in the display 1804. The mobile device 1802 displays the media filter 1840 on top of the media content 1806. In one example embodiment, the media filter 1840 may be implemented with the collection module 608 of FIG. 6A.

FIG. 6E shows a diagram illustrating an example of a viral media filter 1850. The viral media filter 1850 may include dynamic content 1854 and an actionable area 1852. For example, the dynamic content 1854 shows a progress bar and goal of a fundraising event. The progress bar is adjusted based on a latest amount raised. The actionable area 1852 may trigger the mobile device 1802 to cause a financial transaction (e.g., donation) and a communication to another mobile device (e.g., message to another mobile device using the messaging application 120). The mobile device 1802 displays the media filter 1850 on top of the media content 1806. In one example embodiment, the media filter 1850 may be implemented with the progressive use module 610, the viral use module 612, and an actionable module 614 of FIG. 6A.

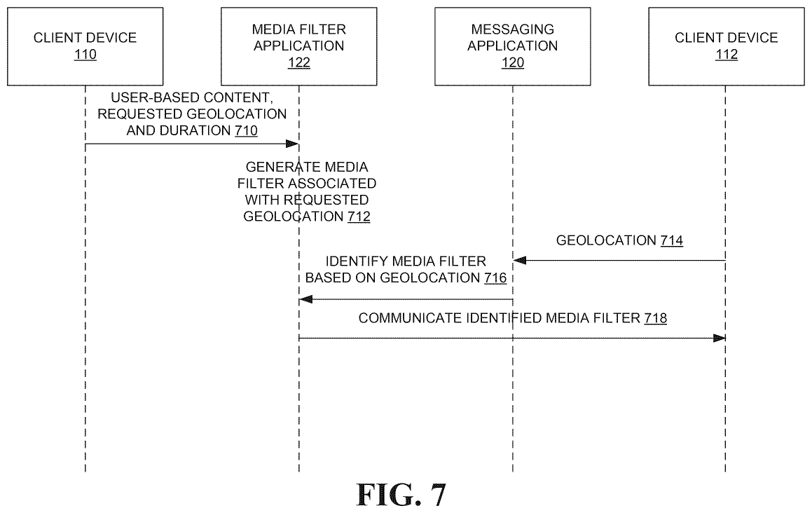

FIG. 7 shows an interaction diagram illustrating one example embodiment of an operation of the user-based media filter publication module 314. At operation 710, the client device 110 of a first user uploads content and sends a requested geolocation and a requested time duration to the media filter application 122. At operation 712, the media filter application 122 generates a media filter based on the uploaded content and associates the media filter with the requested geolocation for the requested time duration. In one example embodiment, operations 710 and 712 may be implemented with the user-based media filter publication module 314 of FIG. 3.

At operation 714, the client device 112 of a second user sends geolocation information to the messaging application 120. At operation 716, the messaging application 120 identifies, from the media filter application 122, a media filter based on the geolocation of the client device 112. At operation 718, the media filter application 122 supplies the client device 112 with the identified media filter. In one example embodiment, operations 716 and 718 may be implemented with the media filter engine 306 of FIG. 3.

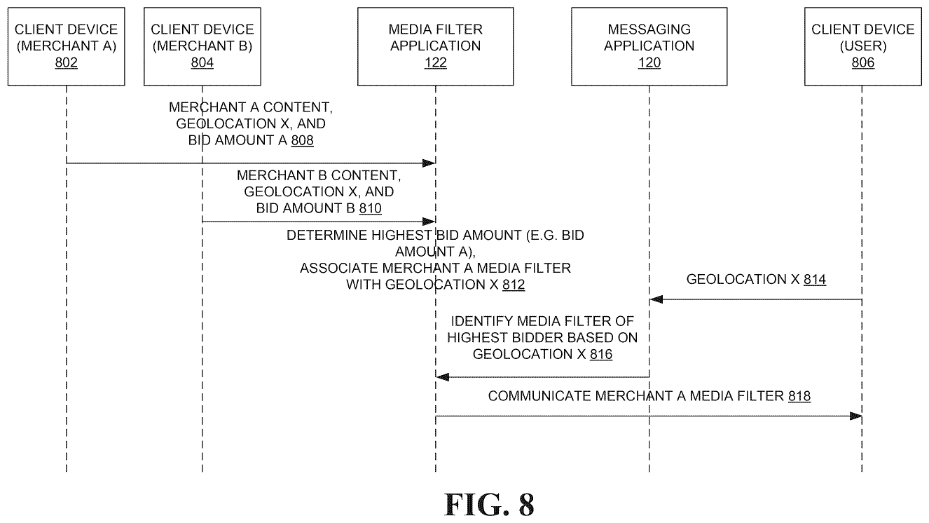

FIG. 8 shows an interaction diagram illustrating another example embodiment of an operation of the merchant-based media filter publication module 316. At operation 808, a client device 802 of merchant A uploads content with geolocation information (e.g., geolocation X) and a bid amount (e.g., bid amount A) to the media filter application 122 to form media filter A. At operation 810, a client device 804 of merchant B uploads content with the same geolocation information (e.g., geolocation X) and a bid amount (e.g., bid amount B) to the media filter application 122 to form media filter B. At operation 812, the media filter application 122 determines a highest bidder, and associates the media filter of the highest bidder with geolocation X. For example, if bid amount A is greater than bid amount B, media filter A is provided to client devices that are located at geolocation X. In one example embodiment, operations 808, 810, 812 may be implemented with the merchant-based media filter publication module 316 of FIG. 3.

At operation 814, a client device 806 at geolocation X sends its geolocation information to the messaging application 120. At operation 816, the messaging application 120 identifies, from the media filter application 122, the media filter associated with the geolocation X. At operation 818, the media filter application 122 supplies the client device 806 with media filter A. In one example embodiment, operations 816 and 818 may be implemented with the media filter engine 306 of FIG. 3. In another example embodiment, the media filter application 122 supplies both media filters A and B to the client device 806 with instructions for the client device 806 to display media filter A first before media filter B since merchant A was the highest bidder.

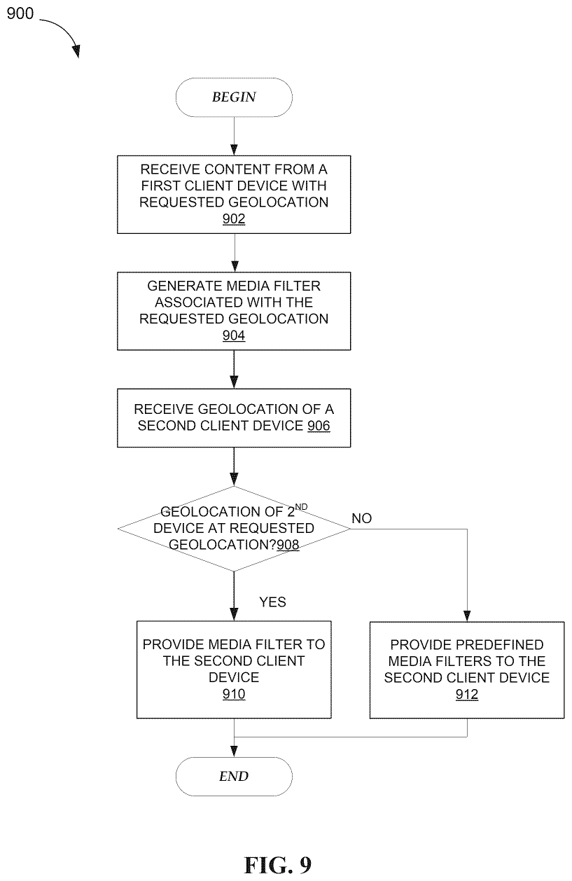

FIG. 9 shows a flow diagram illustrating one example embodiment of a method 900 of the user-based media filter publication module 314. At operation 902, the user-based media filter publication module 314 receives uploaded content and a requested geolocation information from a first client device. In one example embodiment, operation 902 may be implemented with the user-based content upload module 402, the user-based geolocation selection module 404, and the user-based duration selection module 406 of FIG. 4A.

At operation 904, the user-based media filter publication module 314 forms a user-based media filter that includes the uploaded content, and is associated with the requested geolocation. In one example embodiment, operation 904 may be implemented with the user-based publication engine 408 of FIG. 4A.

At operation 906, the user-based media filter publication module 314 receives geolocation information from a second client device. At operation 908, the user-based media filter publication module 314 determines whether the geolocation of the second client device is within the requested geolocation from the first client device. At operation 910, the user-based media filter publication module 314 publishes the user-based media filter from the first client device to the second client device in response to the geolocation of the second client device being within the requested geolocation from the first client device. In one example embodiment, operation 910 may be implemented with the user-based media filter module 320 of FIG. 3.

At operation 912, the media filter engine 306 supplies predefined media filters corresponding to the geolocation of the second client provided to the second device. In one example embodiment, operation 912 may be implemented with the predefined media filter module 318 of FIG. 3.

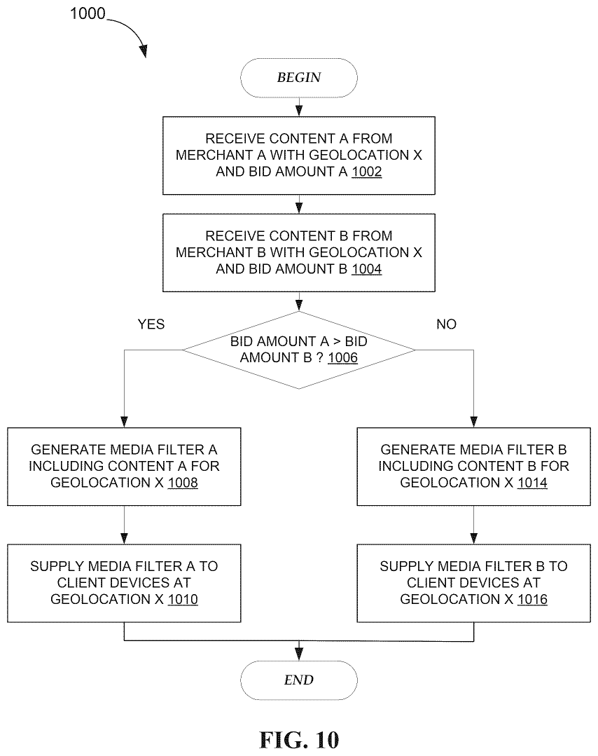

FIG. 10 shows a flow diagram illustrating one example embodiment of a method 1000 of operation for the merchant-based media filter publication module 316. At operations 1002 and 1004, the merchant-based media filter publication module 316 receives uploaded content, geolocation information, and corresponding bid amounts from merchants. For example, at operation 1002, the merchant-based content upload module 502 receives content A from merchant A. The merchant-based geolocation selection module 504 receives geolocation X from merchant A. The merchant-based bidding module 508 receives bid amount A from merchant A.

At operation 1004, the merchant-based content upload module 502 receives content B from merchant B. The merchant-based geolocation selection module 504 receives geolocation X from merchant B. The merchant-based bidding module 508 receives bid amount B from merchant B. The merchant-based publication engine 510 generates a merchant-based media filter B based on content B and geolocation X.

At operation 1006, the highest bid amount is determined. In one example embodiment, operation 1006 may be implemented with the merchant-based bidding module 508 of FIG. 6A. If bid amount A is greater than bid amount B, the merchant-based publication engine 510 generates a merchant-based media filter A based on content A and geolocation X at operation 1008. At operation 1010, the merchant-based media filter module 322 supplies merchant-based media filter A to client devices that are located at geolocation X.

If bid amount B is greater than bid amount A, the merchant-based publication engine 510 generates a merchant-based media filter B based on content B and geolocation X at operation 1014. At operation 1016, the merchant-based media filter module 322 supplies merchant-based media filter B to client devices that are located at geolocation X.

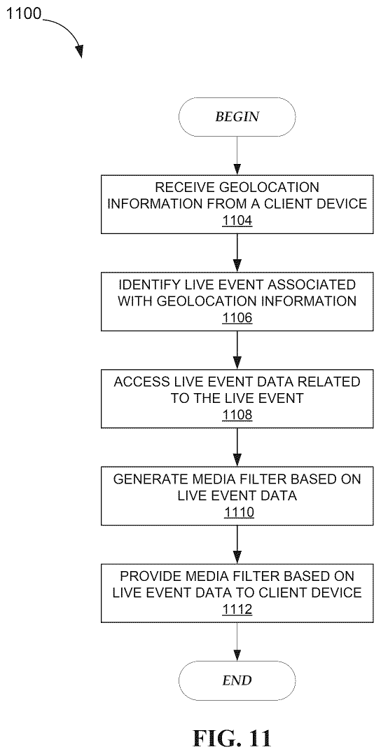

FIG. 11 shows a flow diagram illustrating one example embodiment of a method 1100 of operation for the live event module 602. At operation 1104, the live event module 602 receives geolocation information from a client device. At operation 1106, the live event module 602 identifies a live event associated with the geolocation. At operation 1108, the live event module 602 accesses live event data related to the live event. At operation 1110, the live event module 602 generates a live event media filter based on the live event data. At operation 1112, the live event module 602 supplies the live event media filter to the client device.

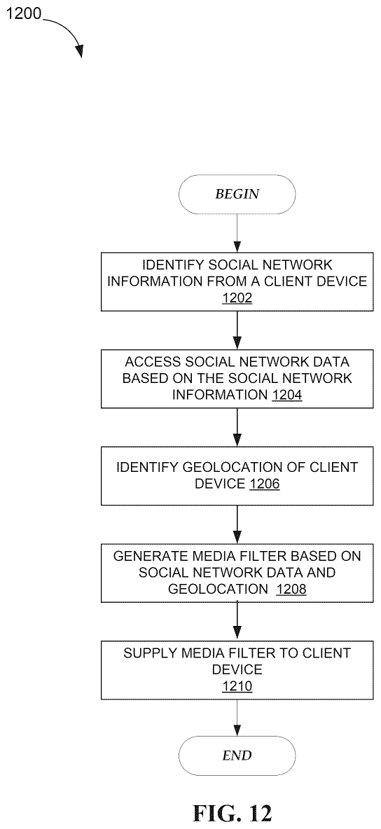

FIG. 12 shows a flow diagram illustrating one example embodiment of a method 1200 of operation for the social network module 604. At operation 1202, the social network module 604 receives social network information from a client device. At operation 1204, the social network module 604 accesses social network data from social network service providers based on social network information from the client device. At operation 1206, the social network module 604 identifies a geolocation from the geolocation information of the client device. At operation 1208, the social network module 604 generates a social network-based media filter based on the social network data and geolocation of the client device. At operation 1210, the social network module 604 supplies the social network-based media filter to the client device.

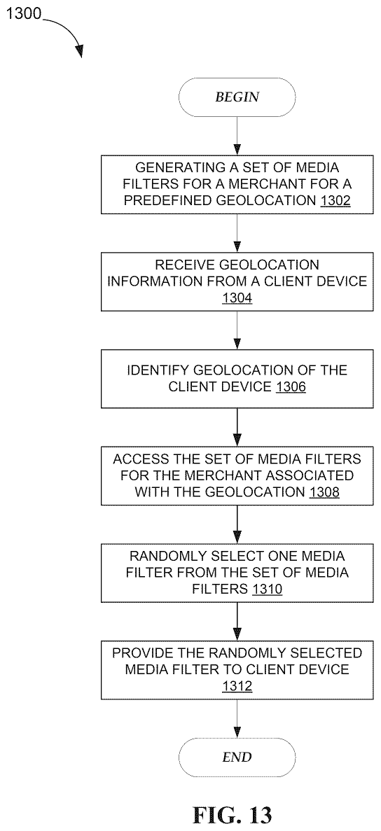

FIG. 13 shows a flow diagram illustrating one example embodiment of a method 1300 of operation for the promotion module 606. At operation 1302, the promotion module 606 generates a set of media filters for a merchant for a predefined geolocation. At operation 1304, the promotion module 606 receives geolocation information from a client device. At operation 1306, the promotion module 606 identifies the geolocation of the client device from the geolocation information. At operation 1308, the promotion module 606 accesses the set of media filters for the merchant associated with the geolocation. At operation 1310, the promotion module 606 randomly selects at least one media filter from the set of media filters. At operation 1312, the promotion module 606 supplies the randomly selected media filter(s) to the client device.

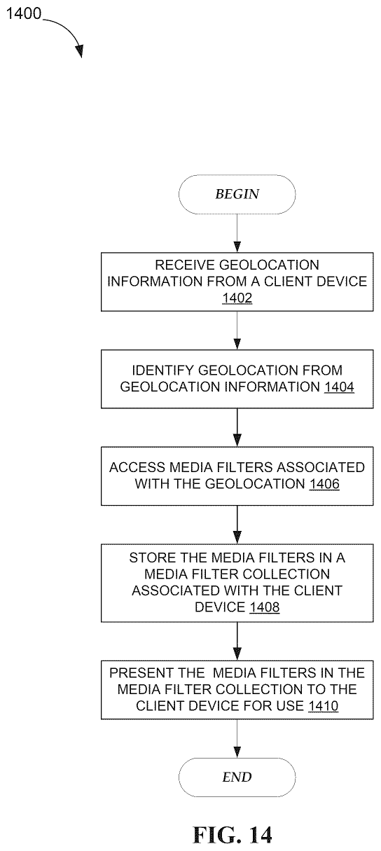

FIG. 14 shows a flow diagram illustrating one example embodiment of a method 1400 of operation for the collection module 608. At operation 1402, the collection module 608 receives geolocation information from a client device. At operation 1404, the collection module 608 determines the geolocation of the client device from the geolocation information. At operation 1406, the collection module 608 accesses media filters associated with the geolocation of the client device. At operation 1408, the collection module 608 stores the media filters in a media filter collection associated with the client device. At operation 1410, the collection module 608 presents the media filters in the media filter collection to the client device for use.

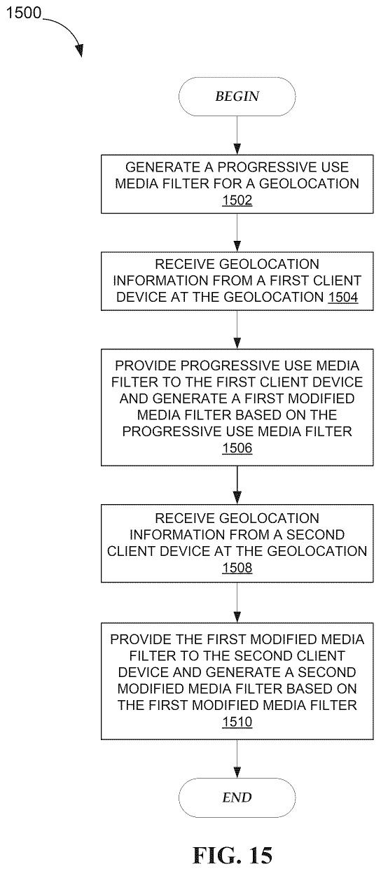

FIG. 15 shows a flow diagram illustrating one example embodiment of a method 1500 of operation for the progressive use module 610. At operation 1502, the progressive use module 610 generates a progressive use media filter for a geolocation. At operation 1504, the progressive use module 610 receives geolocation information from a first client device at the geolocation. At operation 1506, the progressive use module 610 supplies the progressive use media filter to the first client device, and generates a first modified media filter based on the progressive use media filter. At operation 1508, the progressive use module 610 receives geolocation information from a second client at the geolocation. At operation 1510, the progressive use module 610 supplies the first modified media filter to the second client device, and generates a second modified media filter based on the first modified media filter.

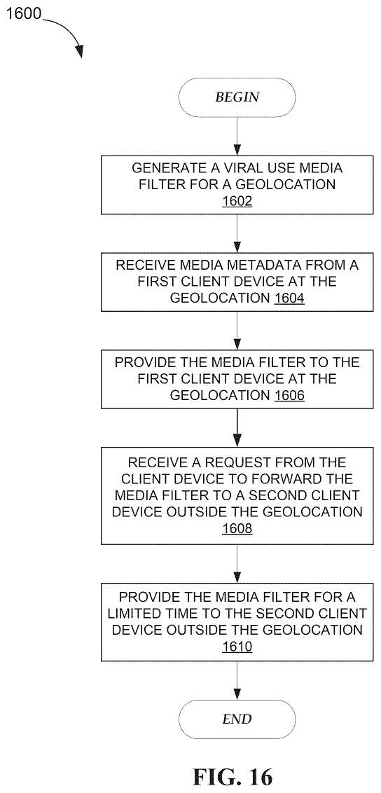

FIG. 16 shows a flow diagram illustrating one example embodiment of a method 1600 of operation for the viral use module 612. At operation 1602, the viral use module 612 generates a media filter for a geolocation. At operation 1604, the viral use module 612 receives geolocation information from a first client device at the geolocation. At operation 1606, the viral use module 612 supplies the media filter to the first client device at the geolocation. At operation 1608, the viral use module 612 receives a request from the first client device to forward the media filter to a second client device outside the geolocation. At operation 1610, the viral use module 612 provides the media filter for a limited time to the second client device outside the geolocation.

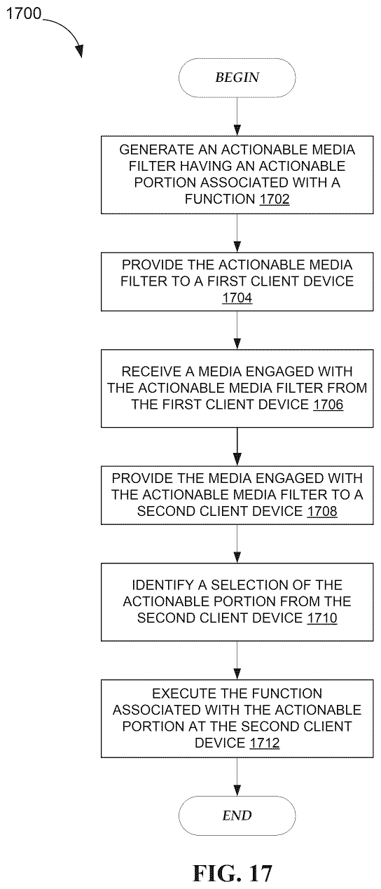

FIG. 17 shows a flow diagram illustrating one example embodiment of a method 1700 of operation for the actionable module 614. At operation 1702, the actionable module 614 generates an actionable media filter having an actionable portion associated with a function. At operation 1704, the actionable module 614 provides the actionable media filter to a first client device. At operation 1706, the actionable module 614 receives a media item (e.g., a photo) with the media filter from the first client device. At operation 1708, the actionable module 614 supplies the media item with the media filter to the second client device. At operation 1710, the actionable module 614 identifies a selection of the actionable portion from the second client device. At operation 1712, the actionable module 614 executes a function associated with the actionable portion at the second client device.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client, or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired), or temporarily or transitorily configured (e.g., programmed) to operate in a certain manner or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respectively different hardware-implemented modules at different times. Software may, accordingly, configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiples of such hardware-implemented modules exist contemporaneously, communications may be achieved through signal transmission (e.g., over appropriate circuits and buses that connect the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), with these operations being accessible via the network 104 (e.g., the Internet) and via one or more appropriate interfaces (e.g., APIs).

### Electronic Apparatus and System

Example embodiments may be implemented in digital electronic circuitry, or in computer hardware, firmware, or software, or in combinations of them. Example embodiments may be implemented using a computer program product (e.g., a computer program tangibly embodied in an information carrier, e.g., in a machine-readable medium for execution by, or to control the operation of, data processing apparatus, e.g., a programmable processor, a computer, or multiple computers).

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., an FPGA or an ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or in a combination of permanently and temporarily configured hardware may be a design choice. Below are set out hardware (e.g., machine) and software architectures that may be deployed in various example embodiments.

### Example Computer System

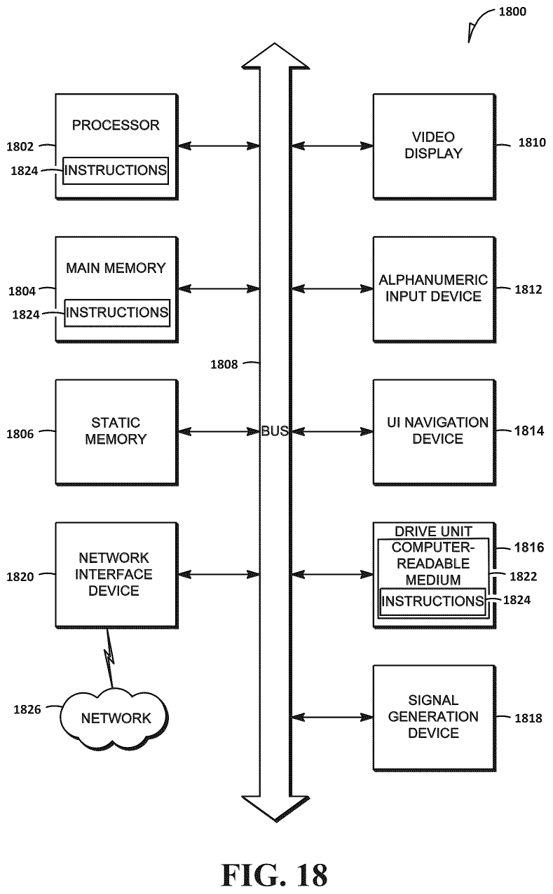

FIG. 18 shows a diagrammatic representation of a machine in the example form of a machine or computer system 1800 within which a set of instructions 1824 may be executed causing the machine to perform any one or more of the methodologies discussed herein. In alternative embodiments, the machine operates as a standalone device or may be connected (e.g., networked) to other machines. In a networked deployment, the machine may operate in the capacity of a server or a client machine 110 and 112 in a server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch or bridge, or any machine capable of executing a set of instructions 1824 (sequential or otherwise) that specify actions to be taken by that machine. Further, while only a single machine is illustrated, the term “machine” shall also be taken to include any collection of machines that individually or jointly execute a set (or multiple sets) of instructions 1824 to perform any one or more of the methodologies discussed herein.

The example computer system 1800 includes a processor 1802 (e.g., a central processing unit (CPU), a graphics processing unit (GPU), or both), a main memory 1804, and a static memory 1806, which communicate with each other via a bus 1808. The computer system 1800 may further include a video display unit 1810 (e.g., a liquid crystal display (LCD) or a cathode ray tube (CRT)). The computer system 1800 also includes an alphanumeric input device 1812 (e.g., a keyboard), a UI navigation device 1814 (e.g., a mouse), a drive unit 1816, a signal generation device 1818 (e.g., a speaker), and a network interface device 1820.

The drive unit 1816 includes a computer-readable medium 1822 on which is stored one or more sets of data structures and instructions 1824 (e.g., software) embodying or utilized by any one or more of the methodologies or functions described herein. The instructions 1824 may also reside, completely or at least partially, within the main memory 1804 or within the processor 1802 during execution thereof by the computer system 1800, with the main memory 1804 and the processor 1802 also constituting machine-readable media.

The instructions 1824 may further be transmitted or received over a network 1826 via the network interface device 1820 utilizing any one of a number of well-known transfer protocols (e.g., HTTP).

While the computer-readable medium 1822 is shown in an example embodiment to be a single medium, the term “computer-readable medium” should be taken to include a single medium or multiple media (e.g., a centralized or distributed database, and/or associated caches and servers) that store the one or more sets of instructions 1824. The term “computer-readable medium” shall also be taken to include any medium that is capable of storing, encoding, or carrying a set of instructions 1824 for execution by the machine that cause the machine to perform any one or more of the methodologies of the present disclosure, or that is capable of storing, encoding, or carrying data structures utilized by or associated with such a set of instructions 1824. The term “computer-readable medium” shall, accordingly, be taken to include, but not be limited to, solid-state memories, optical media, and magnetic media.

Furthermore, the machine-readable medium is non-transitory in that it does not embody a propagating signal. However, labeling the tangible machine-readable medium “non-transitory” should not be construed to mean that the medium is incapable of movement—the medium should be considered as being transportable from one physical location to another. Additionally, since the machine-readable medium is tangible, the medium may be considered to be a machine-readable device.

### Example Mobile Device

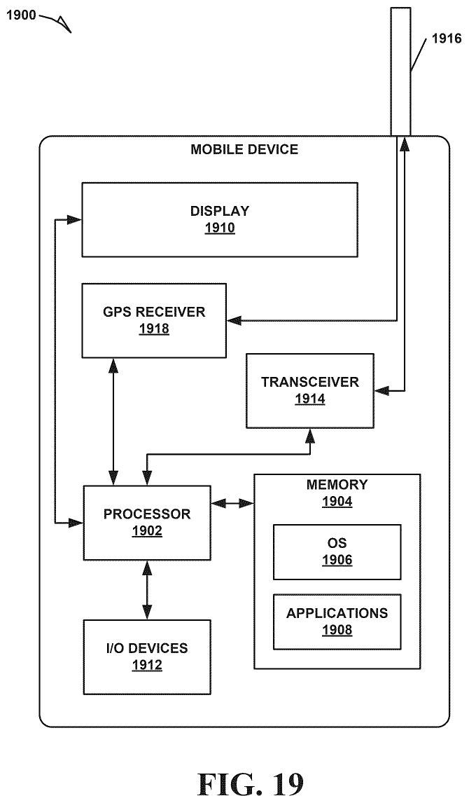

FIG. 19 is a block diagram illustrating a mobile device 1900, according to an example embodiment. The mobile device 1900 may include a processor 1902. The processor 1902 may be any of a variety of different types of commercially available processors 1902 suitable for mobile devices 1900 (for example, an XScale architecture microprocessor, a microprocessor without interlocked pipeline stages (MIPS) architecture processor, or another type of processor 1902). A memory 1904, such as a random access memory (RAM), a flash memory, or another type of memory, is typically accessible to the processor 1902. The memory 1904 may be adapted to store an operating system (OS) 1906, as well as applications 1908, such as a mobile location enabled application that may provide location-based services (LBSs) to a user. The processor 1902 may be coupled, either directly or via appropriate intermediary hardware, to a display 1910 and to one or more input/output (I/O) devices 1912, such as a keypad, a touch panel sensor, a microphone, and the like. Similarly, in some embodiments, the processor 1902 may be coupled to a transceiver 1914 that interfaces with an antenna 1916. The transceiver 1914 may be configured to both transmit and receive cellular network signals, wireless data signals, or other types of signals via the antenna 1916, depending on the nature of the mobile device 1900. Further, in some configurations, a GPS receiver 1918 may also make use of the antenna 1916 to receive GPS signals.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present invention as represented by the appended claims. The specification and drawings are, accordingly, to be regarded in an illustrative rather than a restrictive sense.

Such embodiments of the inventive subject matter may be referred to herein, individually or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A system comprising:
at least one processor;
a memory storing instructions that, when executed by the at least one processor, configure the at least one processor to perform operations comprising:
assigning a priority value to a media filter in association with a first geolocation provided by a first client device, the priority value determining an order in which the media filter is presented relative to other media filters;
sending, to a second client device, identification of a plurality of filters comprising at least the media filter based at least in part on a second geolocation of the second client device, the plurality of filters for presenting on the second device based at least in part on the priority value assigned to the media filter in association with the first geolocation; and
receiving, from the second client device, a message comprising media content overlaid by the media filter.

2. The system of claim 1, the operations further comprising:
supplying the second client device with the media filter in response to the second geolocation being within the first geolocation.

3. The system of claim 1, the operations further comprising:
receiving an identification of a period of time associated with the media content and the first geolocation.

4. The system of claim 1, the operations further comprising:
receiving a first content item from a first merchant and a second content item from a second merchant;
receiving a first geolocation information from the first merchant, and a second geolocation information from the second merchant to identify a common geolocation based on the first geolocation information and the second geolocation information, the common geolocation corresponding to the first geolocation;
receiving a first bid amount from the first merchant and a second bid amount from the second merchant; and
identifying a highest bid amount from the first and second bid amounts.

5. The system of claim 4, the operations further comprising:
generating a merchant-based media filter based on a respective content item of the merchant with the highest bid amount and the common geolocation, the merchant-based media filter corresponding to the media filter; and
disabling the merchant-based media filter after a predetermined duration has elapsed.

6. The system of claim 5, wherein the common geolocation includes a common region formed between a first geolocation from the first merchant and a second geolocation from the second merchant.

7. The system of claim 1, the operations further comprising:
identifying a live event associated with the second geolocation;
accessing live event data related to the live event; and
generating a live event media filter based on the live event data and the second geolocation.

8. The system of claim 1, the operations further comprising:
accessing social network data based on social network information from second client device; and
generating a social network media filter based on the social network data and the social network information from second client device.

9. The system of claim 1, the operations further comprising:
generating a set of media filters including the media filter for a merchant for a predefined geolocation of the merchant, the predefined geolocation corresponding to the first geolocation;
randomly selecting the media filter from the set of media filters; and
providing the media filter to the second client device, in response to the second geolocation corresponding to the predefined geolocation of the merchant.

10. The system of claim 1, the operations further comprising:
storing previously provided media filters in a media filter collection associated with the second client device; and
presenting media filters from the media filter collection associated with second client device in response to receiving a geolocation associated with the media filters.

11. The system of claim 1, the operations further comprising:
generating a progressive use media filter for a predefined geolocation; and
adjusting a content of the progressive use media filter in response to a number of prior uses of the progressive use media filter.

12. The system of claim 11, the operations further comprising:
disabling the progressive use media filter after the number of prior uses of the progressive use media filter reaches a predefined progressive use limit.

13. The system of claim 1, the operations further comprising:
generating a viral use media filter for a predefined geolocation;
providing the viral use media filter to a first client device located at the predefined geolocation;
receiving a request from the first client device located at the predefined geolocation to provide the viral use media filter to the second client device located outside the predefined geolocation; and
providing the viral use media filter to the second client device located outside the predefined geolocation.

14. The system of claim 1, the operations further comprising:
executing a programmable function associated with an actionable area in response to detecting a selection of the actionable area from a user of second client device.

15. The system of claim 1, the operations further comprising:
generating a graphical user interface for displaying a map, receiving a selection of boundaries in the map, and including a geographic region formed with the selection of boundaries in the first geolocation.

16. A method, comprising:
assigning a priority value to a media filter in association with a first geolocation provided by a first client device, the priority value determining an order in which the media filter is presented relative to other media filters;
sending, to a second client device, identification of a plurality of filters comprising at least the media filter based at least in part on a second geolocation of the second client device, the plurality of filters for presenting on the second device based at least in part on the priority value assigned to the media filter in association with the first geolocation; and
receiving, from the second client device, a message comprising media content overlaid by the media filter.

17. The method of claim 16, further comprising:
supplying the second client device with the media filter in response to the second geolocation being within the first geolocation.

18. The method of claim 16, further comprising:
receiving an identification of a period of time associated with the media content and the first geolocation.

19. The method of claim 16, further comprising:
receiving a first content item from a first merchant and a second content item from a second merchant;
receiving a first geolocation information from the first merchant, and a second geolocation information from the second merchant to identify a common geolocation based on the first geolocation information and the second geolocation information, the common geolocation corresponding to the first geolocation;
receiving a first bid amount from the first merchant and a second bid amount from the second merchant; and
identifying a highest bid amount from the first and second bid amounts.

20. A non-transitory computer-readable storage medium, the computer-readable storage medium including instructions that when executed by a computer, cause the computer to perform operations comprising:
assigning a priority value to a media filter in association with a first geolocation provided by a first client device, the priority value determining an order in which the media filter is presented relative to other media filters;
sending, to a second client device, identification of a plurality of filters comprising at least the media filter based at least in part on a second geolocation of the second client device, the plurality of filters for presenting on the second device based at least in part on the priority value assigned to the media filter in association with the first geolocation; and
receiving, from the second client device, a message comprising media content overlaid by the media filter.
